(19) United States
(12) Patent Application Publication
(10) Pub. No.: US 2007/0294437 A1
(43) Pub. Date: Dec. 20, 2007

(54) METHOD FOR AUTOMATICALLY ADJUSTING DRIVING SIGNALS OF A PERIPHERAL DEVICE AND SYSTEMS OF OPERATING THE SAME

(76) Inventor: Feng-Lin Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/762,071

(22) Filed: Jun. 13, 2007

(30) Foreign Application Priority Data
Jun. 14, 2006 (TW) 095121253

(51) Int. Cl. G06F 3/00

(52) U.S. Cl. 710/8; 710/10

(57) ABSTRACT

A method for automatically adjusting driving signals of a peripheral device includes accessing identification data of the peripheral device periodically, and determining whether an accessed identification data differs from a connecting device identification code stored in a signal source. If the accessed identification data differs from the connecting device identification code, the method includes updating the connecting device identification code based on the accessed identification data and outputting the driving signals to the peripheral device based on the updated connecting device identification code.

### BACKGROUND OF THE INVENTION

1. Field of the Invention

The present invention relates to a method for providing driving signals of a peripheral device and systems of operating the same, and more particularly to a method for automatically adjusting driving signals of a peripheral device and systems of operating the same.

2. Description of the Prior Art

With the rapid development of information technologies, the amount and types of electronic products also increase rapidly. Manufacturers co-develop certain standards or protocols that specify data output, data input and data format when transmitting data between a host and a peripheral device. For example, display data channel (DDC) is a communication protocol commonly used between a personal computer (PC) and a display device. Normally, an electrically erasable programmable read only memory (EEPROM) is used for storing the identification data of the display device, such as the extended display identification data (EDID) related to the resolution and the operating timing parameters of the display device.

When the start-up sequence begins, a display card installed in a PC executes “acknowledge handshaking” via inter-integrated circuit (I2C) bus for verifying whether the display device supports the DDC protocol. After completing the “acknowledge handshaking”, the EDID data stored in the EEPROM is accessed and its correctness is verified by means of a checksum. Therefore, the display card of the PC can output corresponding driving signals to the display device based on the accessed EDID data, and the display device can display correct images according to its operating timing parameters and resolution. The operating timing parameters comprises Pixel rate, H_polarity +/−, H_total, H_front porch, H_back porch, H_freq, V_polarity +/−, V_total, V_front porch, V_back porch, V_freq, etc.

Hot-plug is a function that allows users to remove or change display devices or portable discs without turning off the PC and the power supply. Normally, a display device is electrically connected to a PC via D-Sub or digital visual interface (DVI) connectors. For example, in VESA (Video Electronics Standards Association) specifications, the definitions of hardware signals of DVI connectors support the hot-plug function. However, the operating system of a prior art PC and its driving program of the display card do not support the hot-plug function. Several problems may occur when a user performs the hot-plug function and will be described in the following paragraphs.

For instance, if the host refers to a PC, the peripheral device can refer to a low-standard LCD display device supporting 1024x768 resolution and 60 Hz operating frequency, a mid-standard LCD display device supporting 1280x1024 resolution and 70 Hz operating frequency, or a high-standard LCD display device supporting 1600x1200 resolution and 75 Hz operating frequency. If the PC is originally coupled to the mid-standard LCD display device, the PC outputs driving signals corresponding to 1024x768 resolution and 60 Hz operating frequency to the mid-standard LCD display device based on the EDID data accessed from the mid-standard LCD display device during the start-up sequence. If a user replaces the mid-standard LCD display device with the low-standard LCD display device using the hot-plug function, the PC is not informed that an externally coupled display device has been changed, and thus cannot provide corresponding driving signals. Since the resolution of the low-standard LCD display device is lower than the mid-standard LCD display device, when the low-standard LCD display device receives the driving signals corresponding to the resolution and operating timing parameters of the mid-standard LCD display device, the low-standard LCD display device cannot display images correctly. Similarly, if the user replaces the mid-standard LCD display device with the high-standard LCD display device using the hot-plug function, the PC is not informed that an externally coupled display device has been changed, and thus cannot provide corresponding driving signals. Since the resolution of the high-standard LCD display device is higher than the mid-standard LCD display device, when the high-standard LCD display device receives the driving signals corresponding to the resolution and operating timing parameters of the mid-standard LCD display device, the high-standard LCD display device cannot display images with higher resolution. Therefore, after the user replaces an original LCD display device with a new LCD display device using the hot-plug function, the PC has to be re-booted for accessing the EDID data of the new LCD display device and generating appropriate driving signals accordingly. That can bring considerable inconveniences to the users.

Another example usually takes place in events such as conferences or briefings. In these cases, the host usually refers to a notebook computer, and the peripheral device can refer to display devices such as projectors or LCD display devices. Since the resolution of an externally coupled display device can differ from the default resolution of the notebook computer, the users are often required to manually adjust the settings of the notebook computer. If the user does not know the specifications of the external coupled display device in advance, several attempts have to be made for acquiring the best setting, which also bring considerable inconveniences to the users.

### SUMMARY OF THE INVENTION

The present invention provides a method capable of automatically adjusting an information system, the information system including a peripheral device and a signal source that stores a connecting device identification code, the method comprising (a) the signal source periodically accessing an identification data of the peripheral device based on a predetermined frequency; (b) the signal source determining whether the accessed identification data differs from the connecting device identification code; (c) the signal source updating the connecting device identification code based on the accessed identification data if the accessed identification data differs from the connecting device identification code; and (d) the signal source outputting a driving signal to the peripheral device based on the updated connecting device identification code.

The present invention also provides a method capable of automatically adjusting a display system, the display system including a display device and an image source that stores a connecting device identification code, the method comprising (a) the image source periodically accessing an identification data of the display device based on a predetermined frequency; (b) the image source determining whether the accessed identification data differs from the connecting device identification code; (c) the image source updating the connecting device identification code based on the accessed identification data if the accessed identification data differs from the connecting device identification code; and (d) the image source outputting a driving signal to the display device based on the updated connecting device identification code.

The present invention also provides an information system capable of automatically adjusting driving signals comprising a peripheral device including a memory that stores an identification data of the peripheral device; and a signal source electrically connected to the peripheral device and storing a connecting device identification code, the signal source periodically accessing the identification data of the peripheral device based on a predetermined frequency, updating the connecting device identification code based on the accessed identification data if the accessed identification data differs from the connecting device identification code, and outputting a driving signal to the peripheral device based on the updated connecting device identification code.

The present invention also provides a display system capable of automatically adjusting driving signals comprising a display device including a memory that stores an identification data of the display device; and an image source electrically connected to the display device and storing a connecting device identification code, the image source periodically accessing the identification data of the display device based on a predetermined frequency, updating the connecting device identification code based on the accessed identification data if the accessed identification data differs from the connecting device identification code, and outputting a driving signal to the display device based on the updated connecting device identification code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a hierarchical diagram of a PC according to the present invention.

FIG. 2 is a flowchart illustrating a method for automatically adjusting driving signals according to the present invention.

### DETAILED DESCRIPTION

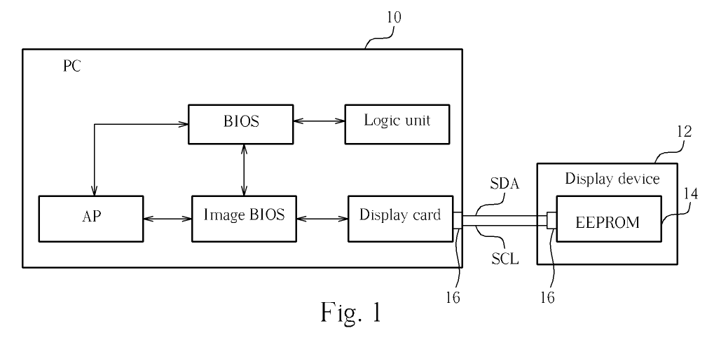

Reference is made to FIG. 1 for a diagram illustrating a PC 10 and a display device 12 according to the present invention. The display device 12 includes a memory unit 14 (such as an EEPROM) that stores data related to the identification data, the resolution and the operating timing parameters of the display device 12 (such as an EDID data). If the PC 10 and the display device 12 adopt the DDC protocol, a data bus (such as an I2C bus) and connectors 16 can be used for transmitting signals between the PC 10 and the display device 12. The I2C bus includes a serial data (SDA) line and a serial clock (SCL) line. The SDA line transmits internal data of the display device 12, such as the brand name, the serial number and the resolution. The SCL line transmits synchronization clocks. The connectors 16 can include D-sub, DVI or other types of connectors.

Also, when the PC 10 and the display device 12 adopt the DDC protocol, the PC 10 demands a 128-byte EDID data from the display device 12 during the start-up sequence. Each address of the 128-byte EDID data corresponds to an identification data or a characteristic. For example, using hex representation, address 0Ah represents the ID product code of the display device 12, address 15h represents the maximum horizontal image size of the display device 12, address 16h represents the maximum vertical image size of the display device 12, addresses 19h-22h represent the color characteristics of the display device 12, and address 7Fh represents the checksum of the display device 12. The definitions of other addresses in the EDID data are described in the VESA specifications and will not be explained in more detail hereafter.

FIG. 1 illustrates the operations between the hardware, the software and the firmware of the PC 10 hierarchically. The basic input output system (BIOS) can include basic software program codes installed in the hardware of the PC 10, or a firmware chip integrated into the hardware of the PC 10. The main function of the BIOS is to provide basic settings for each internal device and peripheral device, such as for display devices, keyboards, processors or memories, so that each internal device and peripheral device can be initiated correctly and function normally. Based on the EDID data accessed from the display device 12 during the start-up sequence, the video BIOS of the PC 10 provides corresponding information to the display card for outputting driving display signal for the display device 12. The display device 12 can thus display images correctly. Also, the present invention periodically verifies the EDID data of the display device 12 by executing an application program (AP). If the display device 12 has been replaced with a new display device, the PC 10 can acquire the EDID data of the new display device immediately and outputs the most appropriate driving programs accordingly. The logic unit of the PC 10 determines whether the above-mentioned auto adjustment function needs to be activated, and activates the AP whether the auto adjustment function has to be activated.

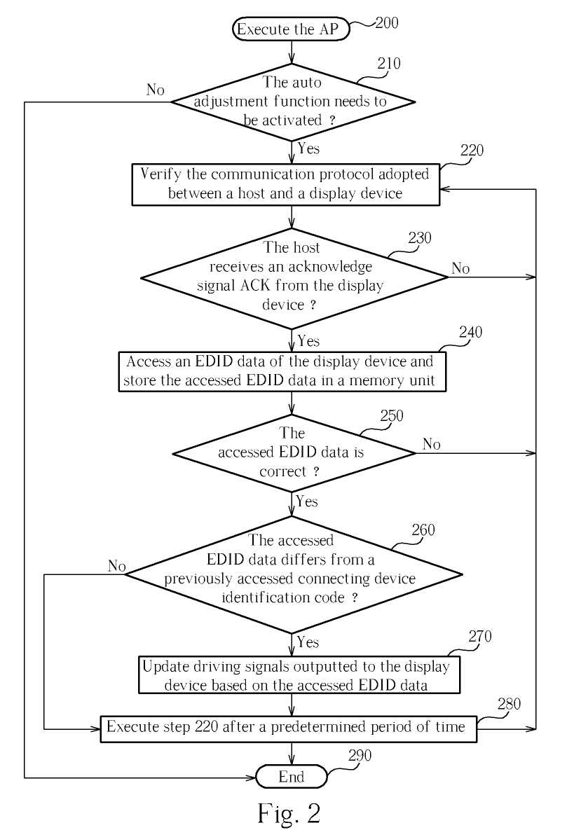

Reference is made to FIG. 2 for a flowchart illustrating a method for automatically adjusting driving signals of a display device. The flowchart in FIG. 2 includes the following steps:

Step 200: execute the AP.

Step 210: determine whether the auto adjustment function needs to be activated: if the auto adjustment function needs to be activated, execute step 220; the auto adjustment function does not need to be activated, execute step 290.

Step 220: verify the communication protocol adopted between a host and a display device.

Step 230: determine whether the host can receive an acknowledge signal ACK from the display device: if the host can receive the acknowledge signal ACK from the display device, execute 240; if the host cannot receive the acknowledge signal ACK from the display device, execute 220.

Step 240: access an EDID data of the display device and store the accessed EDID data in a memory unit.

Step 250: determine whether the accessed EDID data is correct: if the accessed EDID data is correct, execute step 260; if the accessed EDID data is not correct, execute step 220.

Step 260: determine whether the accessed EDID data differs from a previously accessed connecting device identification code: if the accessed EDID data differs from the connecting device identification code, execute step 270; the accessed EDID data is the same as the connecting device identification code, execute step 280.

Step 270: update driving signals outputted to the display device based on the accessed EDID data.

Step 280: execute step 220 after a predetermined period of time.

Step 290: end.

The present invention determines whether the auto adjustment function should be activated in step 210 after executing the AP in step 200. If a user chooses not to activate the auto adjustment function, the present invention executes step 290 and exits the AP directly. Under these circumstances, the host outputs driving signals based on the connecting device identification code accessed during the start-up sequence, regardless of whether the display device is replaced or not.

If a user chooses to activate the auto adjustment function, the present invention executes step 220 for verifying the communication protocol adopted between the host and the display device, and determines whether the host can receive the acknowledge signal ACK from the display device. Take DDC protocol for example. The host verifies address A0h of the EDID data of the display device via the I2C bus. If address A0h of the EDID data responds, it means that the display device (referring to the original display device or to a new display device) and the host adopt the same communication protocol, and are properly electrically connected to each other. The display device responds with the acknowledge signal ACK, informing the host that data is ready to be accessed. If address A0h of the EDID data does not respond, it means the display device and the host are not properly electrically connected to each other. The present invention repeatedly executes step 220 until the host receives the acknowledge signal ACK from the display device. When the user replaces the original display device with a new display device, or the original display device is not properly electrically connected to the host due to external force or other reasons, steps 220 and 230 of the present invention can verify the electrical connection between the host and the display device, and verify the communication protocol adopted by the new display device.

When the host receives the acknowledge signal ACK from the display device (referring to the original display device or to the new display device), step 240 is executed for accessing the EDID data of the display device and storing the accessed EDID data in a memory unit. For DDC protocol, the host receives a 128-byte (or 256-byte) EDID data from the display device. The memory unit can include a buffer, a memory, or other storage devices.

After accessing the EDID data of the display device, step 250 is executed for determining whether the accessed EDID data is correct. For DDC protocol, the checksum can be used for verifying the correctness of the accessed EDID data. If the accessed EDID data is not correct, step 220 is executed again until the correctness of the accessed EDID has been verified.

After accessing the EDID data of the display device and verifying its correctness, step 260 is executed for determining whether the accessed EDID data differs from a previously accessed connecting device identification code. When step 260 is executed for the first time after the host boots up, the connecting device identification code refers to the EDID data accessed from the original display device coupled to the host during the start-up sequence. If the user replaces the original display device with the new display device, the EDID data accessed in step 240 will be different from that accessed during the start-up sequence. Under these circumstances, step 270 is executed for update driving signals outputted to the display device based on the EDID data that is accessed most currently. In addition, if EDID data comprises at least one resolution, a flag is marked on one resolution which is the best mode of the display device. According to the present invention, the host outputs the updated driving signal based on the resolution with the flag. It is the same way that EDID data comprises at least one operating timing parameters. Then in step 280, step 220 is executed after a predetermined period of time such that the host can periodically verify whether the user changes the display device and thereby generates corresponding driving signals. Furthermore, the predetermined period of time could be setup a time shorter than a user changing an another display device. If the predetermined period of time is too long, the driving signal can not updated in time. If the predetermined period of time is too short, the loading of host is heavy. On the other hand, if the user does not replace the original display device, the EDID data accessed in step 240 will be the same as that accessed during the start-up sequence. The host still outputs driving signals to the display device based on the EDID data that is accessed during the start-up sequence. Then in step 280, step 220 is also executed after a predetermined period of time such that the host can periodically verify whether the user changes the display device and thereby generates corresponding driving signals.

The present invention periodically verifies data of a peripheral device via an application program. When a user replaces the peripheral device with a new one using the hot-plug function, the host can acquire data related to the new peripheral device and thereby generates the most appropriate driving signals. In the present invention, the user can successfully perform the hot-plug function without re-booting the host or manually attempting to find the best settings for the new peripheral device. Therefore, the present invention provides a user-friendly and convenient operating environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method capable of automatically adjusting an information system, the information system including a peripheral device and a signal source, the signal source storing a connecting device identification code, the method comprising:
(a) periodically accessing an identification data of the peripheral device based on a predetermined frequency;
(b) determining whether the accessed identification data differs from the connecting device identification code;
(c) updating the connecting device identification code based on the accessed identification data if the accessed identification data differs from the connecting device identification code; and
(d) outputting a driving signal to the peripheral device based on the updated connecting device identification code.

2. The method of claim 1 wherein the step (c) comprises:
updating the connecting device identification code based on the accessed identification data if a first resolution of the accessed identification data differing from a second resolution of the connecting device identification code.

3. The method of claim 1 wherein the step (c) comprises:
updating the connecting device identification code based on the accessed identification data if a first set of operating timing parameters of the accessed identification data differing from a second set of operating timing parameters of the connecting device identification code.

4. The method of claim 1 further comprising:
before executing step (a), determining whether it is necessary to periodically access the identification data of the peripheral device based on the predetermined frequency.

5. The method of claim 1 further comprising:
(a1) before executing step (a), demanding an acknowledge signal from the peripheral device, wherein the acknowledge signal indicates that the identification code of the peripheral device is ready to be accessed.

6. The method of claim 5 wherein before the peripheral device responds to the acknowledge signal, the signal source continues to demand the acknowledge signal from the peripheral device.

7. The method of claim 5 wherein after executing step (a) and before executing step (b), the method further comprises:
determining whether the accessed identification data is correct;
executing step (b) if the accessed identification data is correct; and
executing step (a1) if the accessed identification data is not correct.

8. A method capable of automatically adjusting a display system, the display system including a display device and an image source, the image source storing a connecting device identification code, the method comprising:
(a) periodically accessing an identification data of the display device based on a predetermined frequency;
(b) determining whether the accessed identification data differs from the connecting device identification code;
(c) updating the connecting device identification code based on the accessed identification data if the accessed identification data differs from the connecting device identification code; and
(d) outputting a driving signal to the display device based on the updated connecting device identification code.

9. The method of claim 8 further comprising:
before executing step (a), determining whether it is necessary to periodically access the identification data of the display device based on the predetermined frequency.

10. The method of claim 8 further comprising:
(a1) before executing step (a), demanding an acknowledge signal from the display device, wherein the acknowledge signal indicates that the identification code of the display device is ready to be accessed.

11. The method of claim 10 wherein before the display device responds to the acknowledge signal, the image source continues to demand the acknowledge signal from the display device.

12. The method of claim 10 wherein after executing step (a) and before executing step (b), the method further comprises:
determining whether the accessed identification data is correct;
executing step (b) if the accessed identification data is correct; and
executing step (a1) if the accessed identification data is not correct.

13. A display system capable of automatically adjusting driving signals comprising:
a display device including a memory that stores an identification data of the display device; and
an image source electrically connected to the display device and storing a connecting device identification code, the image source periodically accessing the identification data of the display device based on a predetermined frequency, updating the connecting device identification code based on the accessed identification data if the accessed identification data differs from the connecting device identification code, and outputting a driving signal to the display device based on the updated connecting device identification code.

14. The display system of claim 13 wherein the connecting device identification code comprises a first resolution and the identification data comprises a second resolution when the second resolution differs from the first resolution, the image source outputting the driving signal to the display device based on the second resolution.

15. The display system of claim 13 wherein the connecting device identification code comprises a first set of operating timing parameters and the identification data comprises a second set of operating timing parameters when the second set of timing parameters differs from the first set of operating timing parameters, the image source outputting the driving signal to the display device based on the second set of operating timing parameters.

16. The display system of claim 13 wherein the image source further comprises a logic unit for determining whether it is necessary to periodically access the identification data of the display device based on the predetermined frequency.

17. The information system of claim 13 wherein the image source demands an acknowledge signal from the display device, the acknowledge signal indicating that the identification code of the display device is ready to be accessed.

18. The display system of claim 17 wherein before the display device responds to the acknowledge signal, the image source continues to demand the acknowledge signal from the display device.

19. The information system of claim 17 wherein the image source further comprises a logic unit for determining whether the accessed identification data is correct, determining whether the accessed identification data differs from the connecting device identification code if the accessed identification data is correct, and demanding the acknowledge signal from the display device if the accessed identification data is not correct.
